(19) United States
(12) Patent Application Publication
(10) Pub. No.: US 2015/0041049 A1
(43) Pub. Date: Feb. 12, 2015

(54) METHOD FOR MAKING CURVED TOUCH MODULE

(71) Applicant: TIANJIN FUNAYUANCHUANG TECHNOLOGY CO.,LTD., Tianjin (CN)

(72) Inventors: HAN-CHUNG CHEN, New Taipei (TW); CHIH-HAN CHAO, New Taipei (TW); PO-SHENG SHIH, New Taipei (TW)

(21) Appl. No.: 14/452,545

(22) Filed: Aug. 6, 2014

(30) Foreign Application Priority Data
Aug. 9, 2013 (CN) 2013103455536

(51) Int. Cl. B32B 38/00; G06F 3/041

(52) U.S. Cl. CPC B32B 38/0036; G06F 3/041; G06F 2203/04103; B32B 2313/04
USPC 156/212

(57) ABSTRACT

A method of making a curved touch module with curved surface includes following steps. A first substrate with a curved surface is provided. A carbon nanotube composite structure is formed by locating a carbon nanotube conductive layer on a second substrate surface. The carbon nanotube composite structure is suspended above the first substrate, wherein the carbon nanotube conductive layer faces the curved surface. The carbon nanotube composite structure is curved by applying gas pressure onto the carbon nanotube composite structure, wherein the carbon nanotube composite structure is attached on the curved surface.

### CROSS-REFERENCE TO RELATED APPLICATIONS

This application claims all benefits accruing under 35 U.S.C. §119 from China Patent Application No. 201310345553.6, filed on Aug. 9, 2013, in the China Intellectual Property Office, the disclosure of which is incorporated herein by reference.

### FIELD

The present disclosure relates to a method of making curved touch module with curved surface, particularly to a method of making curved touch module with curved carbon nanotube film.

### BACKGROUND

In recent years, with the development of the high performance of electronic devices such as mobile phone and touch navigation systems, liquid crystal displays mounted with a transparent touch module in front of the electronic devices are gradually increased. Thus, the electronic devices have various functions.

Resistive touch module and capacitive touch module are two common types. The resistive touch module includes at least one transparent electrode layer. However, in the method of making resistive touch module and capacitive touch module, an ITO (indium-tin oxide) glass is used as the transparent electrode layer. Because the ITO glass is a brittle material, and the toughness is limited, thus the resistive touch module and capacitive touch module is limited to planar surface which is only applied in the flat liquid crystal displays.

What is needed, therefore, is to provide a method of making touch module with curved surface for solving the problem discussed above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 shows a schematic flowchart of a first embodiment of making a curved touch module.

FIG. 2 shows a schematic view of one embodiment of a device for making the curved touch module of FIG. 1.

FIG. 3 shows a schematic view of one embodiment of a first substrate in the device of FIG. 2.

FIG. 4 shows a section view of one embodiment of a die of in the device of FIG. 2.

FIG. 5 shows a photo image of the die of FIG. 3.

FIG. 6 shows a scanning electron microscope image of a drawn carbon nanotube film.

FIG. 7 shows a schematic view of one embodiment of a fixture in the device of FIG. 2.

FIG. 8 shows a schematic flowchart of a second embodiment of making a curved touch module.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

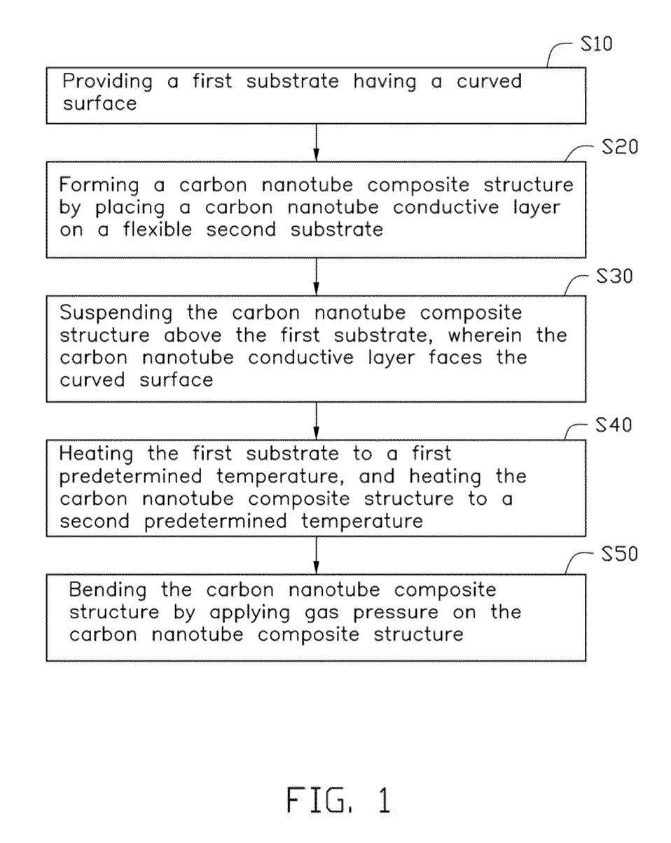

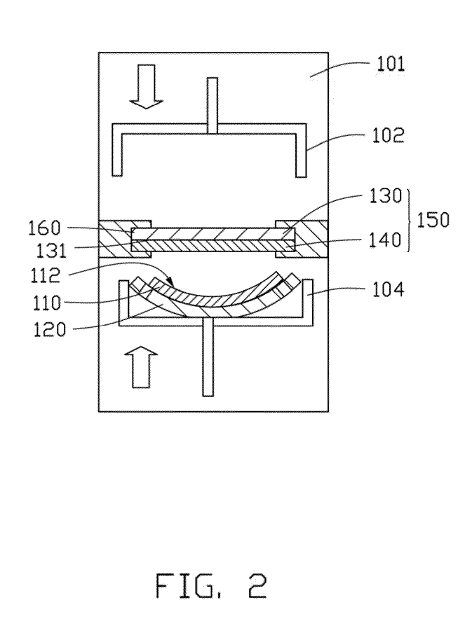

Referring to FIGS. 1-2, a first embodiment of a method for making a curved touch module with curved surface is illustrated. Each block shown in FIG. 1 represents one or more processes, methods, or subroutines, carried out in the method. Furthermore, the illustrated order of blocks is illustrative only. Additional blocks can be added without departing from this disclosure. The method can begin at block S10.

In block S10, providing a first substrate 110 having a curved surface 112.

In block S20, forming a carbon nanotube composite structure 150 by placing a carbon nanotube conductive layer 140 on a flexible second substrate 130.

In block S30, suspending the carbon nanotube composite structure 150 above the first substrate 110, wherein the carbon nanotube conductive layer 140 faces the curved surface 112.

In block S40, heating the first substrate 110 to a first predetermined temperature, and heating the carbon nanotube composite structure 150 to a second predetermined temperature; and

In block S50, bending the carbon nanotube composite structure 150 by applying gas pressure on the carbon nanotube composite structure 150.

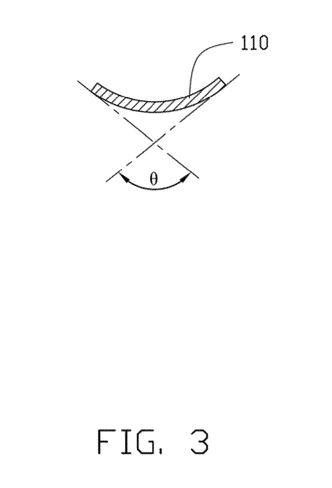

In block S10, referring to FIG. 3, the first substrate 110 can be a curved structure. At least one surface of the first substrate 110 is curved to form the curved surface 112. In one embodiment, the two opposite surfaces of the first substrate 110 are curved. Thus the first substrate 110 is a curved plate with a uniform thickness.

The curved surface 112 can be a smooth surface. The curved surface 112 can be a surface bent along single dimension, two dimensions, or three dimensions. Thus the curved surface 112 can be a single curved surface, double curved surface, or free-form surface. In one embodiment, the curved surface 112 can be a free-form surface.

In one embodiment, a radian θ of the curved surface 112 at each point on the curved surface 112 can be selected according to need. The radian θ can range from about 115 degrees to about 180 degrees. The radian θ can also range from about 90 degrees to about 115 degrees. In one embodiment, the radian θ is greater than 100 degrees and smaller than 115 degrees. At the same time, a radius of the curved surface 112 can be smaller than 5 millimeters.

The curved surface 112 can be a convex surface protruding out of the inside of the first substrate 110. The curved surface 112 can also be a concave surface sinking into the inside of the first substrate 110. A material of the first substrate 110 has a high temperature resistance. The first substrate 110 will not be melted or deformed under the temperature about 160° C. The material of the substrate 110 can be glasses, ceramic or resin. In one embodiment, the material of the substrate 110 is polymethyl methacrylate (PMMA). A thickness of the substrate 110 can range from about 1 millimeter to about 1 centimeter.

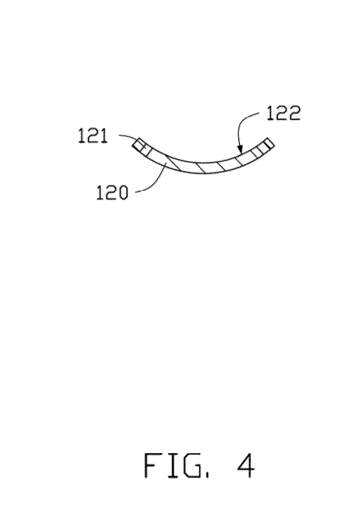

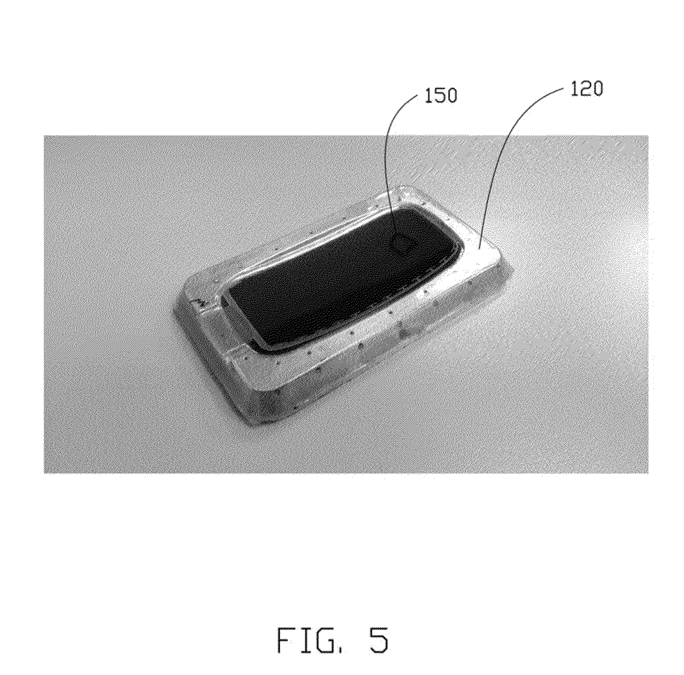

Referring to FIGS. 4-5, a mold 120 can be applied to support the first substrate 110. The mold 120 defines a plurality of through holes 121. The plurality of through holes 121 penetrate the mold 120 along a thickness of the mold 120. The plurality of through holes 121 can be distributed on the edge of the mold 120. Thus the plurality of through holes 121 cannot be blocked by the first substrate 110.

The mold 120 has a first surface 122 to fix the first substrate 110 thereon. The first surface 122 can also be a curved surface. Furthermore, the first surface 122 can be coupled with the first substrate 110. Thus the first substrate 110 can be completely attached and fixed on the first surface 122.

The material of the mold 120 can be Bakelite (phenolic), or metal such as copper, iron, or other heat-resistant material. A thickness of the mold 120 can range from about 2 centimeters to about 3 centimeters.

In block S20, the material of the second substrate 130 can be a thermoplastic material. Furthermore, the material of the second substrate 130 can be a flexible material. The flexible material can be polycarbonate (PC), polymethyl methacrylate (PMMA), polyethylene terephthalate (PET) and other polyester materials, and polyether sulfone (PES), cellulose esters, polyvinyl chloride (PVC), benzocyclobutene (BCB), or acrylic resin. In one embodiment, the material of the second substrate 130 is PET. The thermoplastic material may be rigid at room temperature, but can be transferred into plastic material or flexible material while the thermoplastic material is heated to a predetermined temperature.

The second substrate 130 can have a uniform thickness. The thickness of the second substrate 130 ranges from about 0.1 millimeters to about 1 centimeter. In one embodiment, the thickness of the second substrate 130 ranges from about 0.1 millimeters to about 0.5 millimeters, and the second substrate 130 has better flexibility. The second substrate 130 has a second surface 131. The second surface 131 is a plat surface for conveniently attaching the carbon nanotube conductive layer 140.

The carbon nanotube conductive layer 140 can be attached on the second surface 131 of the second substrate 130. In one embodiment, the carbon nanotube conductive layer 140 can be directly attached on the second surface 131. Furthermore, the carbon nanotube conductive layer 140 can also be attached on the second surface 131 via an adhesive layer (not shown). The material of the adhesive layer can be an Optical Clear Adhesive (OCA).

The carbon nanotube conductive layer 140 can be transparent. The carbon nanotube conductive layer 140 comprises a plurality of carbon nanotubes parallel with each other. The plurality of carbon nanotubes are oriented substantially parallel with the second surface 131. In one embodiment, the carbon nanotube conductive layer 140 comprises at least one carbon nanotube film. The carbon nanotube film comprises a plurality of carbon nanotubes orderly aligned. The plurality of carbon nanotubes are substantially aligned along the same direction. The carbon nanotube conductive layer 140 can be an anisotropic impedance layer defining a relatively low impedance direction parallel with the alignment of the plurality of carbon nanotubes, and a relatively high impedance direction perpendicular to the relative low impedance direction.

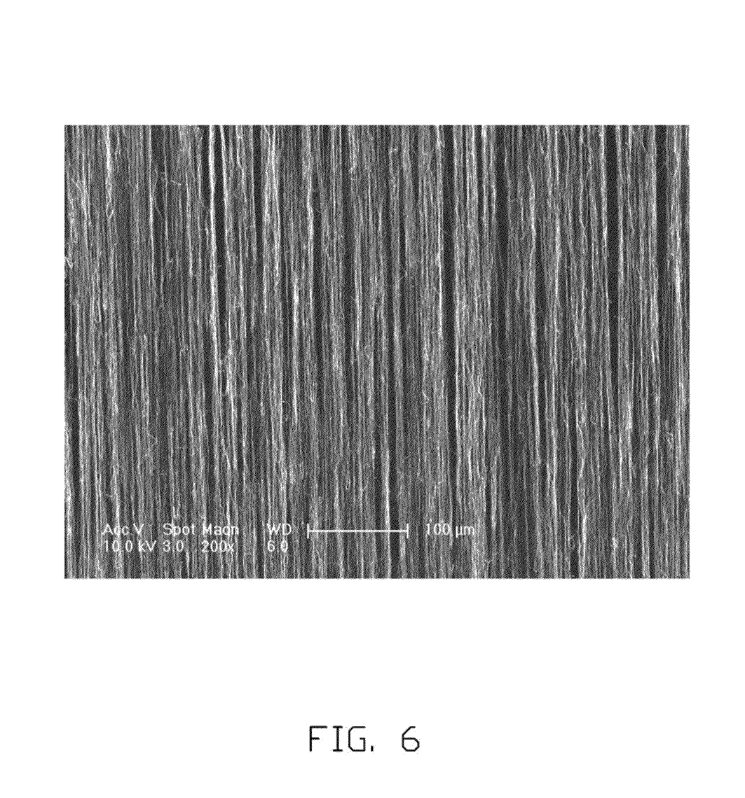

Referring to FIG. 6, the carbon nanotube conductive layer 140 can be a drawn carbon nanotube film. In one embodiment, the carbon nanotube conductive layer 140 comprises a plurality of drawn carbon nanotube film stacked together. A thickness of the carbon nanotube conductive layer 140 can ranges from about 0.5 nanometers to about 1 millimeter. In one embodiment, the thickness of the carbon nanotube conductive layer 140 ranges from about 100 nanometers to about 0.1 millimeters. The transmittance of the carbon nanotube conductive layer 140 is related with the thickness of the carbon nanotube conductive layer 140. The thinner the carbon nanotube conductive layer 140, the better the transmittance of the carbon nanotube conductive layer 140. The transmittance of the carbon nanotube conductive layer 140 can reach 90%. The drawn carbon nanotube film has a large specific surface area, thus the drawn carbon nanotube film can be directly attached to second surface 131.

The carbon nanotube film can be formed by drawing the film from a carbon nanotube array. The overall aligned direction of a majority of the carbon nanotubes in the carbon nanotube film is substantially aligned along the same direction and substantially parallel to a surface of the carbon nanotube film. The carbon nanotube is joined to adjacent carbon nanotubes end to end by van der Waals force therebetween, and the carbon nanotube film is capable of being a free-standing structure. A support having a large surface area to support the entire free-standing carbon nanotube film is not necessary, and only a supportive force at opposite sides of the film is sufficient. The free-standing carbon nanotube film can be suspended and maintain its film state with only supports at the opposite sides of the film. When disposing (or fixing) the carbon nanotube film between two spaced supports, the carbon nanotube film between the two supports can be suspended while maintaining its integrity. The successively and aligned carbon nanotubes joined end to end by van der Waals attractive force in the carbon nanotube film is one main reason for the free-standing property. The carbon nanotube film drawn from the carbon nanotube array has good transparency. In one embodiment, the carbon nanotube film is substantially a pure film and consists essentially of the carbon nanotubes, and to increase the transparency of the touch panel, the carbon nanotubes are not functionalized.

The plurality of carbon nanotubes in the carbon nanotube film have a preferred orientation along the same direction. The preferred orientation means that the overall aligned direction of the majority of carbon nanotubes in the carbon nanotube film is substantially along the same direction. The overall aligned direction of the majority of carbon nanotubes is substantially parallel to the surface of the carbon nanotube film, thus parallel to the surface of the polarizing layer. Furthermore, the majority of carbon nanotubes are joined end to end therebetween by van der Waals force. In this embodiment, the majority of carbon nanotubes are substantially aligned along the same direction in the carbon nanotube film, with each carbon nanotube joined to adjacent carbon nanotubes at the aligned direction of the carbon nanotubes end to end by van der Waals force. There may be a minority of carbon nanotubes in the carbon nanotube film that are randomly aligned, but the number of randomly aligned carbon nanotubes is small compared to the majority of substantially aligned carbon nanotubes and therefore will not affect the overall oriented alignment of the majority of carbon nanotubes in the carbon nanotube film.

In the carbon nanotube film, the majority of carbon nanotubes that are substantially aligned along the same direction may not be completely straight. Sometimes, the carbon nanotubes can be curved or not exactly aligned along the overall aligned direction, and can deviate from the overall aligned direction by a certain degree. Therefore, it cannot be excluded that partial contacts may exist between the juxtaposed carbon nanotubes in the majority of carbon nanotubes aligned along the same direction in the carbon nanotube film. Despite having curved portions, the overall alignment of the majority of the carbon nanotubes are substantially aligned along the same direction.

The carbon nanotube film includes a plurality of successive and oriented carbon nanotube segments. The plurality of carbon nanotube segments are joined end to end by van der Waals attractive force. Each carbon nanotube segment includes a plurality of carbon nanotubes that are substantially parallel to each other, and the plurality of parallel carbon nanotubes are in contact with each other and combined by van der Waals attractive force therebetween. The carbon nanotube segment can have a desired length, thickness, uniformity, and shape. The carbon nanotubes in the carbon nanotube film have a preferred orientation along the same direction. The carbon nanotube wires in the carbon nanotube film can consist of a plurality of carbon nanotubes joined end to end. The adjacent and juxtaposed carbon nanotube wires can be connected by the randomly aligned carbon nanotubes. There can be clearances between adjacent and juxtaposed carbon nanotubes in the carbon nanotube film. A thickness of the carbon nanotube film at the thickest location is about 0.5 nanometers to about 100 microns (e.g., in a range from 0.5 nanometers to about 10 microns).

In block S30, the carbon nanotube composite structure 150 can be suspended above the curved surface 112. In one embodiment, the curved surface 112 is a concave surface, and the carbon nanotube conductive layer face the curved surface 112. In one embodiment, the curved surface 112 is a convex surface, and the carbon nanotube conductive layer 140 is spaced from the curved surface 112 by the second substrate 130.

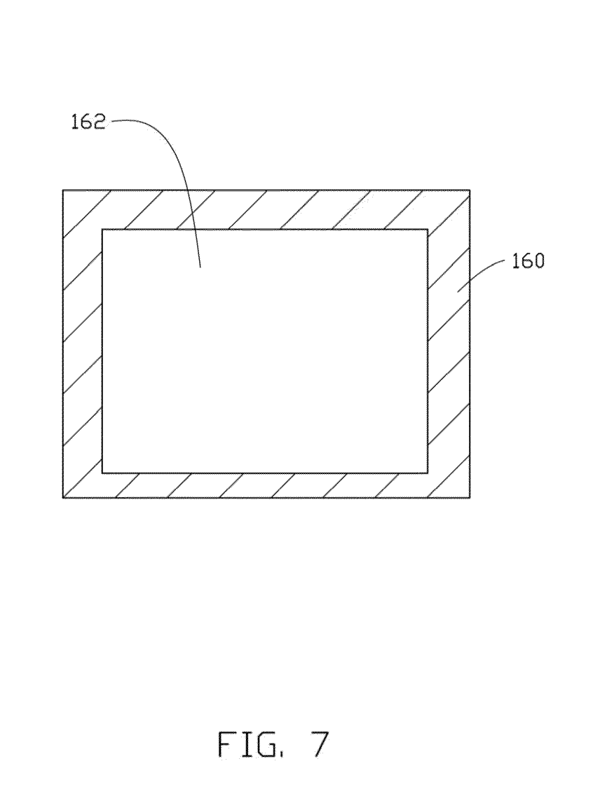

Referring to FIG. 7, the carbon nanotube composite structure 150 can be fixed in the furnace 101 via a clamp 160 fixed on the inside wall of the furnace 101. The clamp 160 is spaced from the curved surface 112 of the second substrate 130. The clamp 160 is a hollow structure with an opening 162. The carbon nanotube composite structure 150 defines a first portion and a second portion. The first portion of the carbon nanotube composite structure 150 can be fixed on the clamp 160. The second portion is suspended through the opening 162. The carbon nanotube composite structure 150 can be firmly fixed in the furnace 101 through the clamp 160, and the second portion of the carbon nanotube composite structure 150 can be planar or remains natural state. In one embodiment, the clamp 160 is in a shape of fringe frame.

In block S40, the first substrate 110 can be heated by the furnace 101. The furnace 101 can be a vacuum heating furnace. The furnace 101 comprises a first carrier plate 102 and a second carrier plate 104 spaced from and parallel with each other. The first substrate 110 can be fixed on the second carrier plate 104, and the curved surface 112 faces the first carrier plate 102. The first substrate 110 can be heated to the first predetermined temperature by heating the second carrier plate 104 with the furnace 101. Furthermore, the first carrier plate 102 defines a first through hole (not shown), and the second carrier plate 104 defines a second through hole (not shown). The pressure can be applied on the two opposite surfaces of the carbon nanotube composite structure 150 through the first through hole and the second through hole.

The material of the first carrier plate 102 and the second carrier plate 104 can be metal or alloy. In one embodiment, the first carrier plate 102 is substantially inversed U-shaped, and the second carrier plate 104 is in a shape of substantially U-shaped.

The first predetermined temperature can be selected according to the material of the carbon nanotube composite structure 150, which ensure that temperature of the environment around the carbon nanotube composite structure 150 has great stability. The first predetermined temperature ranges from about 100° C. to about 190° C.

The carbon nanotube composite structure 150 can be heated by a heating device (not shown) such as metallic heating tube. The heating device can generate infrared rays to heat the carbon nanotube composite structure 150. Furthermore, the heating devices can be located adjacent to the two opposite surfaces of the carbon nanotube composite structure 150. Thus the carbon nanotube composite structure 150 can be uniformly heated. The temperature of the heating device can range from about 120° C. to about 220° C. Thus the second predetermined temperature can range from about 120° C. to about 220° C. In one embodiment, the temperature of the heating device is about 160° C.

The second predetermined temperature can be selected according to the material of the carbon nanotube composite structure 150, which ensure that the carbon nanotube composite structure 150 has great flexibility and scalability. Furthermore, the carbon nanotube composite structure 150 cannot be damaged under the second predetermined temperature. A difference between the first predetermined temperature and the second predetermined temperature is smaller than 50° C. Thus the carbon nanotube conductive layer 140 in the carbon nanotube composite structure 150 has great flexibility and scalability.

The heating time can ensure that the carbon nanotube composite structure 150 can be uniformly heated to the second predetermined temperature. Thus the carbon nanotube composite structure 150 is uniformly flexible. The heating time can range from about 5 seconds to about 30 seconds. In one embodiment, the first predetermined time is about 15 seconds.

In block S50, the gas pressure is directly applied on the carbon nanotube composite structure 150. The carbon nanotube composite structure 150 can be bent by the gas pressure. The carbon nanotube composite structure 150 can be bent by following steps: first step, fixing the clamp 160 by pushing the first carrier plate 102 and the second carrier plate 104 toward each other;

second step, applying a positive pressure on the carbon nanotube composite structure 150 through the first carrier plate 102 and applying a negative pressure on the carbon nanotube composite structure 150 through the second carrier plate 104 for a second predetermined time; and

third step, stopping applying the positive pressure and the negative pressure and separating the first carrier plate 102 and the second carrier plate 104.

In the first step, the first carrier plate 102 and the second carrier plate 104 can be closed by pushing them toward each other via a hydraulic device or pneumatic device. The clamp 160 can be fixed between the first carrier plate 102 and the second carrier plate 104. The second portion of the carbon nanotube composite structure 150 can also be proximate to the curved surface 112.

In the second step, the positive pressure can be applied on the carbon nanotube composite structure 150 via an air cylinder through the first carrier plate 102. The positive pressure can push the carbon nanotube composite structure 150 toward the curved surface 112. Since the first portion of the carbon nanotube composite structure has firmly fixed by the clamp 160, the second portion of the carbon nanotube composite structure 150 can be deformed toward the curved surface 112 under the positive pressure. The positive pressure can range from about 0.5 MPa to about 10 MPa. The carbon nanotube composite structure 150 cannot be damaged under the positive pressure.

At the same time, the negative pressure can be applied on the carbon nanotube composite structure 150 via another air cylinder through the second carrier plate 104. The negative pressure can attract the carbon nanotube composite structure 150 toward the curved surface 112. The second portion of the carbon nanotube composite structure 150 can be deformed toward the curved surface 112 under the negative pressure. The negative pressure can range from about 0.5 MPa to about 10 MPa. The carbon nanotube composite structure 150 cannot be damaged under the positive pressure and the negative pressure.

Under the positive pressure and the negative pressure, a pressure difference can be formed between the two opposite surfaces of the carbon nanotube composite structure 150. The carbon nanotube composite structure 150 will be gradually attached on the curved surface 112 from the central portion of the carbon nanotube composite structure 150. Eventually, the entire second portion of the carbon nanotube composite structure 150 will be attached on the curved surface. The shape of the carbon nanotube composite structure 150 will be bent along the curved surface 112. Furthermore, the conductivity of the carbon nanotube composite structure 150 is not affected by the deformation. It can be understood that, in this step, a few of carbon nanotubes may be broken. However, the broken carbon nanotubes do not affect the conductivity and transparence of the carbon nanotube composite structure 150, and the carbon nanotube conductive structure 110 is still a free-standing structure.

It can be understood that the carbon nanotube composite structure 150 can also be bent by merely applying the positive pressure or the negative pressure.

In the third substep, the curved touch module can be obtained by opening the first carrier plate 102 and the second carrier plate 104, and detaching the curved carbon nanotube composite structure 150 from the clamp 160.

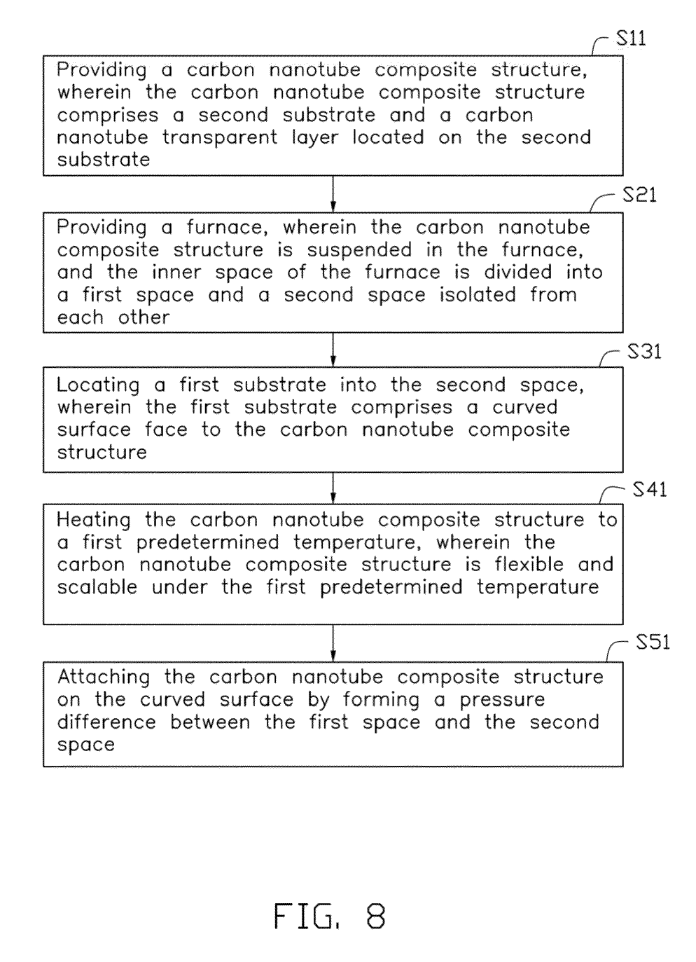

Referring also to FIG. 8, a second embodiment of a method for making a curved touch module with curved surface comprises following blocks.

In block S11, providing a carbon nanotube composite structure 150, wherein the carbon nanotube composite structure 150 comprises a second substrate 130 and a carbon nanotube conductive layer 140 located on the second substrate 130;

In block S21, providing a furnace 101, wherein the carbon nanotube composite structure 150 is suspended in the furnace 101, and the inner space of the furnace 101 is divided into a first space and a second space isolated from each other;

In block S31, locating a first substrate 110 into the second space, wherein the first substrate 110 comprises a curved surface 112 which faces to the carbon nanotube composite structure 150;

In block S41, heating the carbon nanotube composite structure 150 to a first predetermined temperature, wherein the carbon nanotube composite structure 150 is flexible and scalable under the first predetermined temperature;

In block S51, attaching the carbon nanotube composite structure 150 on the curved surface 112 by forming a pressure difference between the first space and the second space.

In block S21, the carbon nanotube composite structure 150 can be located in the center of the furnace 101. Both the first space and the second space are the sealed space.

In block S31, the carbon nanotube conductive layer 140 in the carbon nanotube composite structure 150 can face the curved surface 112 of the first substrate 110.

In block S51, the carbon nanotube composite structure 150 can be bent toward the first substrate 110 by the pressure difference between the first space and the second space. Then the carbon nanotube composite structure 150 will be eventually attached on the curved surface 112.

The method of making curved touch module has following advantages. The carbon nanotube conductive layer has great flexibility, thus it can be easily bent. The carbon nanotube conductive layer is firstly attached on the first substrate to form the carbon nanotube composite structure before being bent, thus the carbon nanotube conductive layer can be easily and tightly attached on the first substrate. Furthermore, the carbon nanotube conductive layer can be protected from being broken due to the first substrate. Thus the life span of the curved touch module can be improved. The method of making curved touch module is convenient for mass production.

It is to be understood that the described embodiments are intended to illustrate rather than limit the disclosure. Any elements described in accordance with any embodiments is understood that they can be used in addition or substituted in other embodiments. Embodiments can also be used together. Variations may be made to the embodiments without departing from the spirit of the disclosure. The disclosure illustrates but does not restrict the scope of the disclosure.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A method of making curved touch module, the method comprising:
providing a first substrate having a curved surface;
forming a carbon nanotube composite structure by attaching a carbon nanotube conductive layer on a second substrate;
suspending the carbon nanotube composite structure above the first substrate, wherein the carbon nanotube conductive layer faces the curved surface;
heating the first substrate to a first predetermined temperature, and heating the carbon nanotube composite structure to a second predetermined temperature; and
bending the carbon nanotube composite structure by applying gas pressure on the carbon nanotube composite structure, so that the carbon nanotube composite structure is attached on the curved surface.

2. The method of claim 1, wherein the first predetermined temperature ranges from about 100° C. to about 190° C.

3. The method of claim 1, wherein the second predetermined temperature ranges from about 120° C. to about 220° C.

4. The method of claim 1, wherein a difference between the first predetermined temperature and the second predetermined temperature is smaller than 30° C.

5. The method of claim 1, wherein a material of the second substrate is a flexible material selected from the group consisting of polycarbonate, polymethyl methacrylate, polyethylene terephthalate and other polyester materials, and polyether sulfone, cellulose esters, polyvinyl chloride, benzocyclobutene, and acrylic resin.

6. The method of claim 1, wherein the carbon nanotube conductive layer is transparent and comprises a plurality of carbon nanotubes substantially aligned along the same direction.

7. The method of claim 6, wherein the plurality of carbon nanotubes are joined end to end along the same direction by van der Waals force.

8. The method of claim 6, wherein the plurality of carbon nanotubes are substantially parallel with a surface of the first substrate.

9. The method of claim 1, wherein the curved surface is a free-form surface.

10. The method of claim 1, wherein a radian θ of the curved surface ranges from about 90 degrees to about 115 degrees, and a radius of the curved surface is smaller than 5 millimeters.

11. The method of claim 1, wherein heating the first substrate comprises:
providing a furnace, wherein the furnace comprises a first carrier plate and a second carrier plate spaced from each other and parallel with each other in the furnace;
fixing the first substrate on the second carrier plate; and
heating the first substrate to the first predetermined temperature by the furnace.

12. The method of claim 11, further comprising: fixing the carbon nanotube composite structure in the furnace via a clamp fixed on the inside wall of the furnace, wherein the clamp is a hollow structure with an opening, and the clamp is located between the first carrier plate and the second carrier plate.

13. The method of claim 12, wherein the carbon nanotube composite structure comprises a first portion and a second portion, the first portion is fixed on the clamp, and the second portion is suspended through the opening.

14. The method of claim 11, further comprising: fixing a mold on the second carrier, wherein the first substrate is located on a mold.

15. The method of claim 14, wherein the mold comprises a first surface capable of being coupled with the first substrate.

16. The method of claim 11, wherein the bending the carbon nanotube composite structure comprises:
fixing the clamp by pushing the first carrier plate and the second carrier plate toward each other;
applying a positive pressure on the carbon nanotube composite structure through the first carrier plate and applying a negative pressure on the carbon nanotube composite structure through the second carrier plate for a second predetermined time; and
stopping applying the positive pressure and the negative pressure and separating the first carrier plate and the second carrier plate.

17. The method of claim 16, wherein the positive pressure push the carbon nanotube composite structure toward the curved surface, and the negative pressure attract the carbon nanotube composite structure toward the curved surface.

18. The method of claim 16, wherein the positive pressure ranges from about 0.5 MPa to about 10 MPa, and the negative pressure ranges from about 0.5 MPa to about 10 MPa.

19. The method of claim 1, wherein the curved surface is a convex surface or a concave surface.

20. A method of making curved touch module, the method comprising :
providing a carbon nanotube composite structure, wherein the carbon nanotube composite structure comprises a second substrate and a carbon nanotube transparent layer located on the second substrate;
placing the carbon nanotube composite structure in a furnace, wherein the carbon nanotube composite structure is suspended in the furnace, and an inner space of the furnace is divided into a first space and a second space isolated from each other;
locating a first substrate into the second space, wherein the first substrate comprises a curved surface facing to the carbon nanotube composite structure;
heating the carbon nanotube composite structure to a predetermined temperature, wherein the carbon nanotube composite structure is flexible and scalable under the predetermined temperature; and
attaching the carbon nanotube composite structure on the curved surface by forming a pressure difference between the first space and the second space.
